(19) United States
(12) Patent Application Publication
(10) Pub. No.: US 2021/0150425 A1
(43) Pub. Date: May 20, 2021

(54) RESERVATION SYSTEM AND RESERVATION METHOD THEREOF

(71) Applicant: Yung-Yen Chen, New Taipei (TW)

(72) Inventor: Yung-Yen Chen, New Taipei (TW)

(21) Appl. No.: 17/160,453

(22) Filed: Jan. 28, 2021

Related U.S. Application Data
(63) Continuation-in-part of application No. 15/873,864, filed on Jan. 17, 2018.

(30) Foreign Application Priority Data
Apr. 12, 2017 (TW) 106112273

(51) Int. Cl. G06Q 10/02; G06Q 10/10; G06Q 30/06; G06Q 30/02; H04L 29/08

(52) U.S. Cl. CPC G06Q 10/02; G06Q 10/1093; H04L 67/02; G06Q 30/0641; G06Q 30/0283; G06Q 30/0631

(57) ABSTRACT

A reservation system and a reservation method thereof are provided. The reservation system includes a remote server, a store-side device and a smart mobile communication device. The remote server provides a main-booking page and a sub-booking page. The main-booking page includes a reservation status Gantt chart corresponding to business information. The store-side device sends the business information to the remote server. The smart mobile communication device displays the main-booking page and the sub-booking page. A user inputs a reservation time which is counted with the minimum unit of one minute. The smart mobile communication device generates and sends reservation information including the reservation time to the remote server. A calculator of the remote server further calculates the reservation time to correspondingly generate reservation pricing information and recommendation reservation time.

### CROSS-REFERENCE TO RELATED APPLICATION

This application is a continuation in part of U.S. patent application Ser. No. 15/873,864, filed on Jan. 17, 2018, in the United States Patent and Trademark Office, which claims the benefit of Taiwanese Patent Application No. 106112273 filed on Apr. 12, 2017, the content of which is incorporated herein in its entirety by reference.

### BACKGROUND OF THE INVENTION

### 1. Field of the Invention

The present invention is related to a reservation system and a reservation method thereof, in particular, related to a reservation status Gantt chart showing on a main-booking website for providing a reservation system reservation time which is counted with one minute as a unit, and a reservation method thereof.

### 2. Description of the Related Art

Generally, reservation methods may be simply classified into verbal reservations and online reservations. Verbal reservations may be walk-in reservations or phone appointment. However, using this reservation method, customers are typically unable to directly check the reservation status, but may need to inquire about different reservation times repeatedly in order to know that which time period may be able to be reserved. Hence, a consumer will be inconvenienced for the reservation process, and their desire of product consumption is further affected.

### SUMMARY OF THE INVENTION

In views of above problems, the object of the present invention is to provide a reservation system and a reservation method thereof for solving the problems faced in prior arts.

Based on to the above object, the present invention provides a reservation system, which comprises a remote server, a store-end device and a smart mobile communication device. The remote server provides a main-booking website corresponding to a request signal and provides a sub-booking website corresponding to a reserve signal. The main-booking website includes a reservation status Gantt chart corresponding to business information, the remote server further includes a calculator to receive reservation information and calculate a reservation time in the reservation information by calculation logic of the calculator to correspondingly generate reservation pricing information. The store-end device sends the business information to the remote server. The smart mobile communication device sends the request signal to the remote server, opens and displays the main-booking website by browser, generates the reserve signal by the clicking one of the time periods in the reservation status Gantt chart within the main-booking website, opens and displays the sub-booking website by browser, and inputs the reservation time which is counted with the minimum unit of one minute. The smart mobile communication device generates and sends reservation information comprising the reservation time to the remote server, wherein the remote server updates the reservation status Gantt chart based on the reservation information and the reservation pricing information.

Preferably, the remote server may provide a back-end website to the store-end device corresponding to a manage signal sent by the store-end device, and the store-end device sets up the business information in the back-end website.

Preferably, the calculation logic is for the calculator to calculate time pricing information corresponding to the reservation time, and divide the reservation time with the minimum unit of one minute based at least one weight value in the time pricing information, the calculator calculates the divided reservation time according to a pricing formula to obtain the reservation pricing information.

Preferably, the pricing formula is:

RP=(T₁p×T₁w+T₂p×T₂w)×SP

RP represents the reservation pricing information, T₁p represents a regular price of a first reservation time divided in the reservation time, T₁w represents a first weight value corresponding to the first reservation time, T₂p represents a regular price of a second reservation time divided in the reservation time, T₂w represents a second weight value corresponding to the second reservation time, SP is a set parameter.

Preferably, when the remote server received the reservation information, the calculator further generates a recommendation reservation time by calculating the reservation time in the reservation information with an evaluated operation time, and the remote server outputs the recommendation reservation time to the smart mobile communication device.

Preferably, the evaluated operation time is generated by the calculator calculating a plurality of evaluation values corresponding to at least one requested item in the request signal, and the calculator further requires a difference value between the reservation time and the evaluated operation time when the calculator calculating the reservation time with the evaluated operation time, and adjusts the evaluated operation time according to an adjusting value calculated by the difference value with a request condition parameter corresponding to the request signal to generate the recommendation reservation time.

Preferably, the reservation status Gantt chart may comprise a plurality of time periods comprising a reservation only period, a reserved period, a free period, a rest period, a walk-in period, a non-business period or a combination thereof.

Preferably, the main-booking website may comprise a plurality of subscriber information.

Preferably, the sub-booking website may comprise a date selection column, a plurality of subscriber information columns or a combination thereof.

Based on the above object, the present invention further provides a reservation method adapted to a reservation system comprising a remote server, a store-end device and a smart mobile communication device. The reservation method comprises: sending business information and generating a main-booking website including a reservation status Gantt chart corresponding to the business information; opening a browser of the smart mobile communication device and sending a request signal; receiving the request signal and providing the main-booking website; clicking one of time periods in the reservation status Gantt chart within the main-booking website and sending a reserve signal; receiving the reserve signal and providing a sub-booking website; inputting a reservation time which is counted with the minimum unit of one minute and sending reservation information to the remote server; and receiving the reservation information by a calculator in the remote server, and calculating the reservation time by calculation logic of the calculator to correspondingly generate reservation pricing information.

Preferably, the reservation method may further comprise steps as follows: sending a manage signal to the remote server; providing a back-end website to the store-end device; and setting up the business information in the back-end website.

As mentioned above, the reservation system and the reservation method thereof of the present invention may allow staff to arrange working progress or business time, and may allow consumers to self-determine and to select a time period for receiving services according to the reservation status Gantt chart. In addition, the reservation system and the reservation method thereof of the present invention may achieve a reservation service which is counted with the minimum unit of one minute. Hence, both the provider of service and consumer may handle their time more accurately, so that the economic benefits are improved.

### BRIEF DESCRIPTION OF THE DRAWINGS

FIG. 1 is a block diagram of the reservation system of the present invention.

FIG. 2 is a block diagram of information transmission of the reservation system of the present invention.

FIG. 3 is a schematic view of the main-booking website of the reservation system of the present invention.

FIG. 4 is a schematic view of the sub-booking website of the reservation system of the present invention.

FIG. 5 is a flow chart of the reservation method of the present invention.

### DESCRIPTION OF THE PREFERRED EMBODIMENTS

For the ease of understanding the technical features, contents, advantages and effects of the present invention, the detailed description of the present invention will be represented by the embodiments in cooperation with the appended drawings hereinafter, which are only intended to be illustrative and to support the specification, and may not to be the substantial proportion and the accurate configuration after the implementation of the present invention. Hence, the scope of the present invention in actual implementation should not be limited to the interpretation of the proportion and the relationship of the configuration in the appended drawings.

The advantages, features and the technical solutions will be described in detail referring to the exemplary embodiments and the appended drawings and will be understood more easily. Further, the present invention may be implemented in various forms, and should not be realized in limitation of the embodiments mentioned herein. On the contrary, the embodiment provided will enable the present disclosure to be more thoroughly and comprehensively and fully conveyed with respect to the scope of the invention via a person skilled in the related art. Further, the present invention is merely limited to the definition of the appended claims.

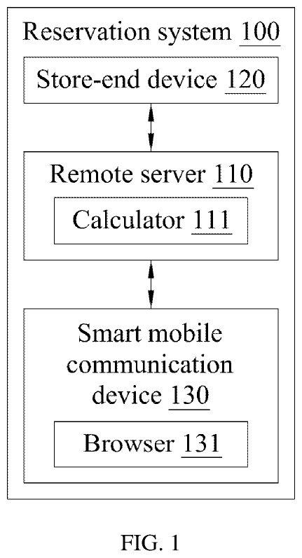

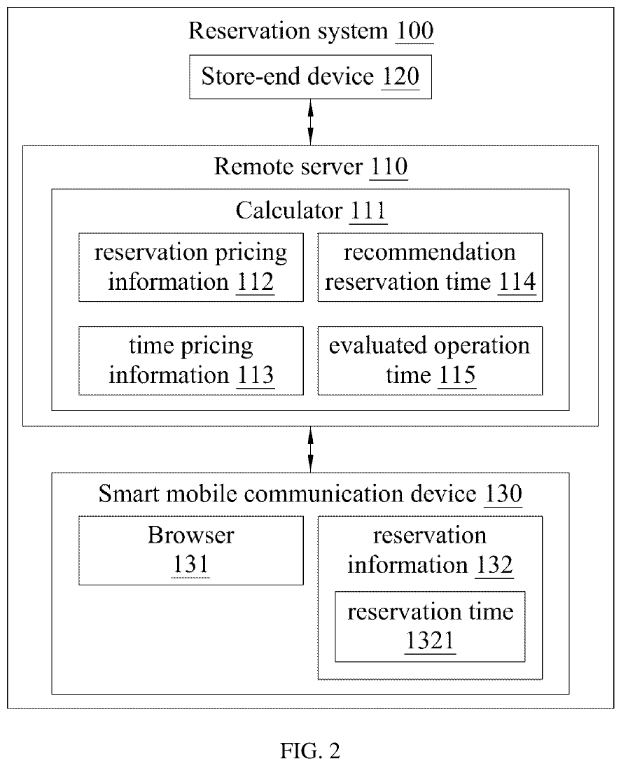

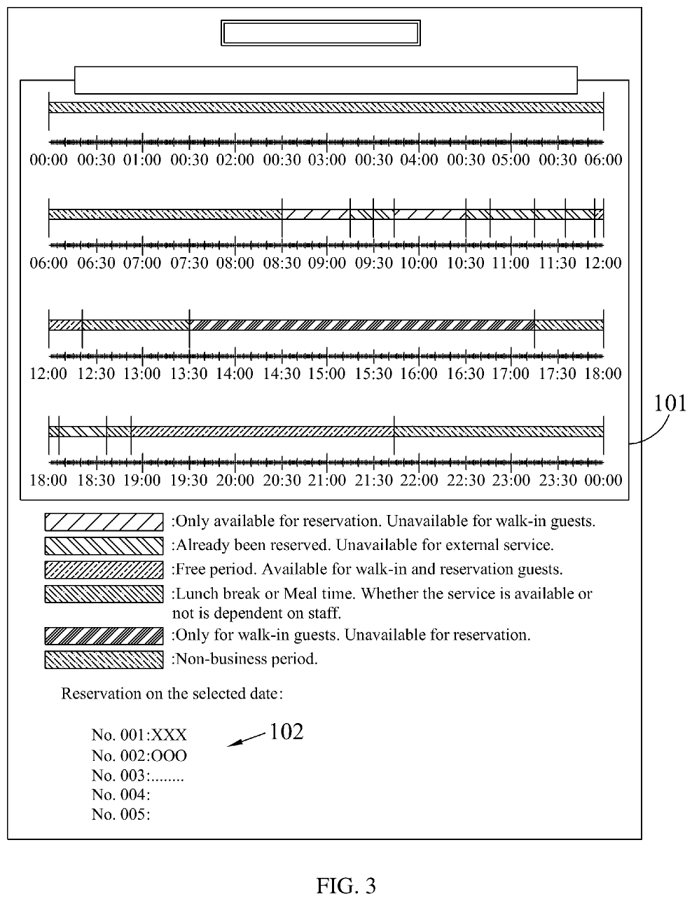

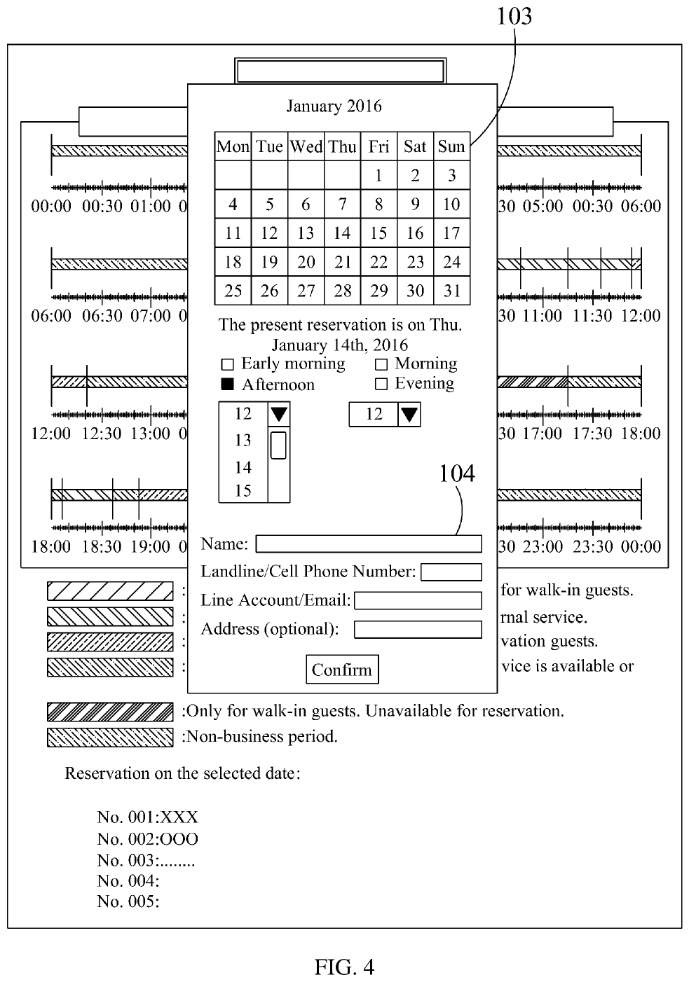

Please refer to FIGS. 1 to 4. FIG. 1 is the block diagram of the reservation system of the present invention. FIG. 2 is a block diagram of information transmission of the reservation system of the present invention. FIG. 3 is a schematic view of the main-booking website of the reservation system of the present invention. FIG. 4 is a schematic view of the sub-booking website of the reservation system of the present invention. As shown in the drawings, the reservation system 100 of the present invention comprises a remote server 110, a store-end device 120 and a smart mobile communication device 130. Wherein, the remote server 110 connects to the store-end device 120 and the smart mobile communication device 130 through the internet individually. The store-end device 120 is an electronic device having the functions of internet connection, data transmission and website displaying. The smart mobile communication device 130 may be a smart phone or a tablet.

Further, the remote server 110 provides a main-booking website corresponding to a request signal, and provides a sub-booking website to the smart mobile communication device 130 corresponding to a reserve signal. The main-booking website has a reservation status Gantt chart 101 corresponding to the business information.

The store-end device 120 sends the business information to the remote server 110. The remote server 110 may generate a main-booking web site having the reservation status Gantt chart based on the business information, of which the business information comprises business time, reservation related information and configurations of various time periods.

The smart mobile communication device 130 sends a request signal to the remote server 110. The remote server 110 receives the main-booking website, opens and displays the main-booking website by a browser 131. One of time periods (the time period here indicates a time interval that the user needs to make a reservation (e.g. 15:15 to 17:57), rather than a fixed or set time period (for example, the time period is calculated in hourly (e.g. 15:00 to 15:30)) in the reservation status Gantt chart 101 within the main-booking website is clicked and a reserve signal is sent to the remote server 110. The remote server 110 receives the sub-booking website, opens and displays the sub-booking website by a browser. A reservation time 1321 which is counted with the minimum unit of one minute is input. Subsequently, the smart mobile communication device 130 generates and sends reservation information 132 comprising the reservation time 1321 to the remote server 110 in order to finish a reservation process.

More in detail, the store-end device 120 sets up the business information and sends the business information to the remote server 110 so that the remote server 110 is able to update the main-booking web site and the reservation status Gantt chart 101 correspondingly. The store-end device 120 may send a manage signal to the remote server 110. Then, the remote server 110 provides a back-end website to the store-end device 120 correspondingly so that the store-end device 120 is able to set up the business information in the back-end website, and to upload to the remote server 110.

Whereas, the reservation status Gantt chart 101 may comprise a plurality of time periods, comprising a reservation only period, a reserved period, a free period, a rest period, a walk-in period, a non-business period or a combination thereof.

Furthermore, a calculator 111 which is arranged in the remote server 110 is able to generate reservation pricing information 112 corresponding to the reservation time 1321 in the reservation information 132 calculated by calculation logic of the calculator 111 when the remote server 110 received the reservation information 132. Accordingly, both a provider of service and consumer can check the reservation pricing information 112 through the smart mobile communication device 130 or the store-end device 120 to confirm the actual price of the reservation.

Specifically, an outputted laboring is closely related to time, so it is available that using the time as a calculation basis of a price and calculating with related-elements to require a listed price when the outputted laboring has been priced. In addition, for avoiding a profit costs loss caused by wasting redundant time (e.g. restricting hourly reservation (15:00 to 15:30) may lead to 10 minutes of the profit costs loss due to an operation of the outputted laboring only takes 20 minutes). Thus, in order to relatively increase the level of freedom of the reservation, the present invention provides the consumer to reserve in a manner of inputting with the minimum unit of one minute, for relatively reducing the profit costs loss caused by wasting redundant time.

Therefore, when the reservation time 1321 in the reservation information 132 calculated by the calculation logic of the calculator 111, time pricing information 113 corresponding to the reservation time 1321 can be priory calculated by the calculator 111, then dividing the reservation time 1321 with the minimum unit of one minute based on at least one weight value in the time pricing information 113. For example, the time pricing information 113 may determine the reservation time 1321 (when the reservation time 1321 is 15:15 to 17:57) according to for example a reservation date (holiday or weekday), a discounting time period (e.g. 14:00 to 17:00), or a peak time period (e.g. 17:00 to 21:00), etc. and divide the reservation time 1321 with the minimum unit of one minute based on at least one weight value in the time pricing information 113, which means that the time period of 15:15 to 17:00 in the reservation time 1321 is corresponding to 0.85 of the weight value when the weight value of the discounting time period is 0.85, and the time period of 17:00 to 17:57 in the reservation time 1321 is corresponding to 1.2 of the weight value when the weight value of the peak time period is 1.2, then further adjusting a set parameter (e.g. holiday is 1.1, weekday is 0.9) based on the reservation date (e.g. holiday).

Accordingly, the calculator 111 can calculate the divided the reservation time 1321 according to the pricing formula as following to obtain the reservation pricing information 112.

the pricing formula:

RP=(T₁p×T₁w+T₂p×T₂w)×SP

RP represents the reservation pricing information 112, T₁p represents a regular price of a first reservation time divided in the reservation time 1321, T₁w represents a first weight value corresponding to the first reservation time, T₂p represents a regular price of a second reservation time divided in the reservation time 1321, T₂w represents a second weight value corresponding to the second reservation time, SP is the set parameter.

While calculating based on the pricing formula, assuming the hourly price of the outputted laboring is 15 dollars per hour, the divided first reservation time is 15:15 to 17:00, so that the regular price of the first reservation time shall be 15 (dollars)×1.75 (hours)=26.26 (dollars), and the divided second reservation time is 17:00 to 17:57, so that the regular price of the second reservation time shall be 15 (dollars)×0.95 (hours)=14.25 (dollars). Applying to the pricing formula, the reservation pricing information 112 will be 43.3631 (dollars), 43.3631 (RP)=(26.26×0.85+14.25×1.2)×1.1.

Consequently, the remote server 110 is able to update the reservation status Gantt 101 chart based on the reservation information 132 and the reservation pricing information 112 when the reservation information 132 and the reservation pricing information 112 are generated, and provide both the provider of service and consumer check the reservation information 132 and the reservation pricing information 112 on the reservation status Gantt chart 101.

Therefore, the present application provides the consumer to input the reservation time 1321 with the minimum unit of one minute, and correspondingly pricing the outputted laboring to increase the level of freedom of the reservation, and reduce the profit costs loss caused by wasting redundant time.

On the other hand, the present application further generates a recommendation reservation time 114 by the calculator 111 to provide an optimal reservation time to the consumer. In detail, when the reservation information 132 is generated, the calculator 111 of the remote server 110 can further calculate the reservation time 1321 in the reservation information 132 with an evaluated operation time 115, wherein the evaluated operation time 115 here represents a calculated result by calculating a plurality of evaluation values corresponding to at least one requested item in the request signal, for example, each of the evaluation values can be previously recorded operation time with same of the requested item, and the requested item is a service item (e.g. services of cutting hair or consulting), the calculator 111 here is able to use such as weight value, averaging, or optimization algorithm to calculate the plurality of evaluation values and generate the evaluated operation time 115.

The reservation time 1321 and the evaluated operation time 115 usually record a different time interval. Thus, a difference value (e.g. 20 minutes) between the reservation time 1321 (e.g. 15:00 to 16:30) and the evaluated operation time 115 (e.g. 15:00 to 16:10) can be required by the calculator 111 when the calculator 111 calculates the reservation time 1321 with the evaluated operation time 115, and the calculator 111 adjusts the evaluated operation time 115 according to an adjusting value calculated by the difference value with a request condition parameter (e.g. raining day may plus 15 minutes, or the peak time period may plus 30 minutes) corresponding to the request signal and generates the recommendation reservation time 114 (as shown in FIG. 2).

Accordingly, the remote server 110 can provide the recommendation reservation time 114 to the provider of service and/or consumer, to further avoid the profit costs loss caused by wasting redundant time.

As shown in FIG. 3, the main-booking website may comprise a plurality of subscriber information 102 so that the consumers may understand the order of each of the subscribed groups. Wherein, the subscriber information may comprise name, phone number, reservation time and so on.

As shown in FIG. 4, the sub-booking website may comprise a data selecting column 103, a plurality of subscriber information columns 104 or a combination thereof. Wherein, the subscriber information column may comprise the columns for the filing such as name, contact information, address and so on.

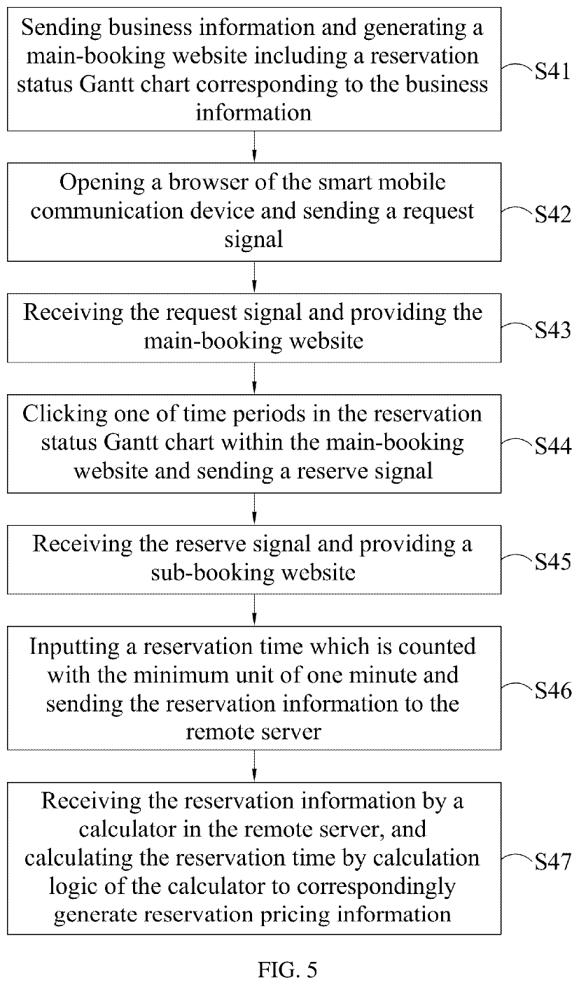

Please refer to FIG. 5, which is a flow chart of the reservation method of the present invention. As shown in the drawings, the reservation method of the present invention is adapted to the reservation system. The reservation system comprises a remote server, a store-end device and a smart mobile communication device. The reservation method comprises:

In step S41: Sending business information and generate a main-booking website including a reservation status Gantt chart corresponding to the business information. The business information is sent from the store-end device to the remote server. The main-booking website is generated by the remote server based on the business information.

In step S42: Opening a browser of the smart mobile communication device and sending a request signal. The request signal is sent from the smart mobile communication device to the remote server.

In step S43: Receiving the request signal and providing the main-booking website. The main-booking website is provided by from the remote server to the smart mobile communication device.

In step S44: Clicking one of time periods in the reservation status Gantt chart within the main-booking website and sending a reserve signal. The reserve signal is sent from the smart mobile communication device to the remote server.

In step S45: Receiving the reserve signal and providing a sub-booking website. The sub-booking website is provided from the remote server to the smart mobile communication device.

In step S46: Inputting a reservation time which is counted with the minimum unit of one minute and sending the reservation information to the remote server.

In step S47: Receiving the reservation information by a calculator in the remote server, and calculating the reservation time by calculation logic of the calculator to correspondingly generate reservation pricing information.

In addition, before the business information is sent by the store-end device, the reservation method may further comprise the steps as follows:

Send a manage signal to the remote server. The manage signal is generated and sent by the store-end device.

Provide a back-end website to the store-end device. The back-end website is generated and sent by the remote server.

Set up the business information in the back-end website. The browser of the store-end device displays the back-end website, so as to configure related settings of the business information in the back-end website.

Accordingly, a detailed description and embodiments of the reservation method of the present invention are already described in the description of the reservation system of the present invention, which will not be repeated here for simplification description.

As mentioned above, the reservation system and the reservation method thereof of the present invention may allow staff to arrange working progress or business time, and may allow consumers self-determine and to select a time period for receiving services by themselves according to the reservation status Gantt chart. In addition, the reservation system and the reservation method thereof of the present invention may achieve a reservation service which is counted with the minimum unit of one minute. Hence, both the provider of service and consumer may handle their time more accurately, so that the economic benefits are improved.

Aforementioned embodiments are merely the explanation of the technical concepts and features of the present invention, are intended to be understood and implemented accordingly by a person skilled in the related art, and are not intended to limit the scope of the present invention. That is, any equivalent variations and modifications following spirit of the present invention are covered in the scope of the claims of the present invention.

What is claimed is:

1. A reservation system, comprising:
a remote server providing a main-booking website corresponding to a request signal and providing a sub-booking web site corresponding to a reserve signal, wherein the main-booking website comprises a reservation status Gantt chart corresponded to business information, the remote server further including a calculator to receive reservation information and calculate a reservation time in the reservation information by calculation logic of the calculator to correspondingly generate reservation pricing information;
a store-end device sending the business information to the remote server; and
a smart mobile communication device sending the request signal to the remote server, opening and displaying the main-booking website by a browser, generating the reserve signal by clicking one of time periods in the reservation status Gantt chart within the main-booking website, and opening and displaying the sub-booking website by the browser and inputting the reservation time which is counted with the minimum unit of one minute, wherein the smart mobile communication device generates and sends the reservation information comprising the reservation time to the remote server;
wherein the remote server updates the reservation status Gantt chart based on the reservation information and the reservation pricing information.

2. The reservation system as claimed in claim 1, wherein the remote server provides a back-end website to the store-end device corresponding to a manage signal sent from the store-end device, and the store-end device sets up the business information in the back-end website.

3. The reservation system as claimed in claim 1, wherein the calculation logic is for the calculator to calculate time pricing information corresponding to the reservation time, and divide the reservation time with the minimum unit of one minute based at least one weight value in the time pricing information, the calculator calculates the divided reservation time according to a pricing formula to obtain the reservation pricing information.

4. The reservation system as claimed in claim 3, wherein the pricing formula is:
RP=(T₁p×T₁w+T₂p×T₂w)×SP
RP represents the reservation pricing information, T₁p represents a regular price of a first reservation time divided in the reservation time, T₁w represents a first weight value corresponding to the first reservation time, T₂p represents a regular price of a second reservation time divided in the reservation time, T₂w represents a second weight value corresponding to the second reservation time, SP is a set parameter.

5. The reservation system as claimed in claim 1, when the remote server received the reservation information, the calculator further generates a recommendation reservation time by calculating the reservation time in the reservation information with an evaluated operation time, and the remote server outputs the recommendation reservation time to the smart mobile communication device.

6. The reservation system as claimed in claim 5, wherein the evaluated operation time is generated by the calculator calculating a plurality of evaluation values corresponding to at least one requested item in the request signal, and the calculator further requires a difference value between the reservation time and the evaluated operation time when the calculator calculating the reservation time with the evaluated operation time, and adjusts the evaluated operation time according to an adjusting value calculated by the difference value with a request condition parameter corresponding to the request signal to generate the recommendation reservation time.

7. The reservation system as claimed in claim 1, wherein the reservation status Gantt chart comprises a plurality of time periods comprising a reservation only period, a reserved period, a free period, a rest period, a walk-in period, a non-business period or a combination thereof.

8. The reservation system as claimed in claim 1, wherein the main-booking website comprises a plurality of subscriber information.

9. The reservation system as claimed in claim 1, wherein the sub-booking website comprises a date selection column, a plurality of subscriber information columns or a combination thereof.

10. A reservation method adapted to a reservation system comprising a remote server, a store-end device and a smart mobile communication device, comprising:
sending business information and generating a main-booking website including a reservation status Gantt chart corresponding to the business information;
opening a browser of the smart mobile communication device and sending a request signal;
receiving the request signal and providing the main-booking website;
clicking one of time periods in the reservation status Gantt chart within the main-booking website and sending a reserve signal;
receiving the reserve signal and providing a sub-booking website; and
inputting a reservation time which is counted with the minimum unit of one minute and sending reservation information to the remote server;
receiving the reservation information by a calculator in the remote server, and calculating the reservation time by calculation logic of the calculator to correspondingly generate reservation pricing information;
updating the reservation status Gantt chart by the remote server based on the reservation information and the reservation pricing information.

11. The reservation method as claimed in claim 10, further comprising steps as follows:
sending a manage signal to the remote server;
providing a back-end website to the store-end device; and
setting up the business information in the back-end website.

12. The reservation system as claimed in claim 10, wherein the calculation logic is for the calculator to calculate time pricing information corresponding to the reservation time, and divide the reservation time with the minimum unit of one minute based at least one weight value in the time pricing information, the calculator calculates the divided reservation time according to a pricing formula to obtain the reservation pricing information.

13. The reservation system as claimed in claim 12, wherein the pricing formula is:
RP=(T₁p×T₁w+T₂p×T₂w)×SP
RP represents the reservation pricing information, T₁p represents a regular price of a first reservation time divided in the reservation time, T₁w represents a first weight value corresponding to the first reservation time, T₂p represents a regular price of a second reservation time divided in the reservation time, T₂w represents a second weight value corresponding to the second reservation time, SP is a set parameter.

14. The reservation system as claimed in claim 10, when the remote server received the reservation information, the calculator further generates a recommendation reservation time by calculating the reservation time in the reservation information with an evaluated operation time, and the remote server outputs the recommendation reservation time to the smart mobile communication device.

15. The reservation system as claimed in claim 14, wherein the evaluated operation time is generated by the calculator calculating a plurality of evaluation values corresponding to at least one requested item in the request signal, and the calculator further requires a difference value between the reservation time and the evaluated operation time when the calculator calculating the reservation time with the evaluated operation time, and adjusts the evaluated operation time according to an adjusting value calculated by the difference value with a request condition parameter corresponding to the request signal to generate the recommendation reservation time.

16. The reservation method as claimed in claim 10, wherein the reservation status Gantt chart comprises a plurality of time periods comprising a reservation only period, a reserved period, a free period, a rest period, a walk-in period, a non-business period or a combination thereof.

17. The reservation method as claimed in claim 10, wherein the main-booking website comprises a plurality of subscriber information.

18. The reservation method as claimed in claim 10, wherein the sub-booking website comprises a date selecting column, a plurality of subscriber information columns or a combination thereof.
